(19) United States
(12) Patent Application Publication
(10) Pub. No.: US 2022/0081882 A1
(43) Pub. Date: Mar. 17, 2022

(54) Well Water System and Modular Adaptor

(71) Applicants: Gregory Hunt, Rolling Prairie, IN (US); Chris Allan Hunt, Rolling Prairie, IN (US)

(72) Inventors: Gregory Hunt, Rolling Prairie, IN (US); Chris Allan Hunt, Rolling Prairie, IN (US)

(21) Appl. No.: 17/531,676

(22) Filed: Nov. 19, 2021

Related U.S. Application Data
(63) Continuation-in-part of application No. 16/669,054, filed on Oct. 30, 2019.

(51) Int. Cl. E03B 5/06; G01L 19/00

(52) U.S. Cl. CPC E03B 5/06; G01L 19/003

(57) ABSTRACT

A well water system includes a two piece modular adaptor that allows the pressure controls to be readily detached from the plumbing of the well water system. The modular adaptor includes a hollow adaptor body and a detachable adaptor coupler, which connects the pressure control and a pressure gauge to the modular adaptor. The detachable coupler allows the pressure controller to be completely disconnected from the well water system without reworking the existing plumbing and reduces the potential of major water leaks.

This application is a continuation-in-part of co-pending application, Ser. No. 16/669,054 filed on Oct. 30, 2019, which claims the benefit of U.S. Provisional Application No. 62/753,006 filed Oct. 30, 2018, the disclosure of which is hereby incorporated by reference.

This invention relates to a well water system, and in particular a system that actuates the well pump based on air pressure within the pressure tank.

### BACKGROUND AND SUMMARY OF THE INVENTION

Well water systems, generally, consist of a well itself, a pump, a pressure tank, a pressure switch for automatically activating the pump and the various connecting plumbing, valves, spigots and faucets. The pressure tank and pressure switch are used to maintain water pressure within the system's plumbing and provide immediate access to well water without operating the pump. The pump sends water from the well to the pressure tank for temporary storage. Pressure tanks use air pressure within the tank to pressurize the water feed back into the plumbing. Most pressure tanks use either internal bladders or diaphragms to separate the stored water from the air inside the tank. The pressure switch actuates the pump in response to a drop in water pressure below the minimum value to replenish the water in the tank and to build up the water pressure in the system to its maximum value. The pressure switch de-actuates the pump when the water pressure reaches the maximum value and the supply is restored.

In conventional practice, the pressure switch directly monitors water pressure in the system plumbing, generally in the water line from the pressure tank's outlet. Integrating the pressure switch into the plumbing requires additional joints, pipes and fittings. While common and generally acceptable in the art, adding more joints, pipes and fittings in the plumbing increases the potential for leaks and failures, as well as additional costs. Since the plumbing carries pressurized well water, any leaks or failures can cause significant damage. Moreover, leak repairs typically require cutting, replacing or re-soldering brass pipes, joints and fittings, which are expensive and time consuming.

### SUMMARY OF THE INVENTION

The well water systems of this invention incorporate a specialized fitting (adaptor) that connects pressure switches into the system plumbing to either monitor water pressure in the water lines or air pressure within the pressure tanks.

In one embodiment, the adaptor is configured to monitor air pressure within the pressure tank, rather than water pressure within the plumbing. The pressure switch is connected directly to the pressure tank by a tank adaptor in fluid communication with the pressurized air inside the tank. With the tank adaptor directly connecting the pressure tank to the pressure switch, the pump is actuated based on air pressure changes within the tank rather than water pressure changes in the plumbing. The pressure switch is calibrated to activate the pump when the air pressure within the pressure tank drops below a predetermined pressure, which correlates to a certain water pressure within the system. When the air pressure within the pressure tank is restored to a predetermined maximum, the pressure switch deactivates the pump having filled the tank to the desired maximum water threshold. Placing the pressure switch in an air line, rather than a water line, eliminates potential water leaks and certain plumbing issues, that can lead to costly water damage to the system and surrounding structures. The use of a pressure switch in the air line, rather than the water line also does not significantly change the configuration or function of any system component, plumbing or wiring, keeping system installation, operation and maintenance familiar, while reducing installation cost and increasing reliability.

In another embodiment, a two piece modular adaptor that allows the pressure controls to be readily detached from the plumbing of the well water system. The modular adaptor includes a hollow adaptor body and a detachable adaptor coupler, which connects the pressure control and a pressure gauge to the modular adaptor. The detachable coupler allows the pressure controller to be completely disconnected from the well water system without reworking the existing plumbing and reduces the potential of major water leaks. The modular adaptor is designed to be installed to conventional PVC water pipes and fittings used in the well water system, which reduces installation and repair costs by eliminating the need to cut, join and solder metal pipes and fittings.

The above described features and advantages, as well as others, will become more readily apparent to those of ordinary skill in the art by reference to the following detailed description and accompanying drawings.

### BRIEF DESCRIPTION OF THE DRAWINGS

The present invention may take form in various system and method components and arrangement of system and method components. The drawings are only for purposes of illustrating exemplary embodiments and are not to be construed as limiting the invention. The drawings illustrate the present invention, in which:

FIG. 1 is a simplified side view of a conventional well water system illustrating an example of the prior art in the field;

FIG. 2 is a simplified side view of an exemplary well water system of this invention;

FIG. 3 is an exploded view of the pressure tank adaptor and pressure switch of this invention as shown in FIG. 2;

FIG. 4 is an exploded view of the pressure tank, tank adaptor and pressure switch of this invention as shown in FIG. 2;

FIG. 5 is a simplified side view of another exemplary well water system of this invention;

FIG. 6 is a perspective view of another exemplary tank adaptor of this invention; and

FIG. 7 is an exploded view of the tank adaptor of FIG. 6;

FIG. 8 is a perspective view of an exemplary embodiment of a modular adaptor of this invention for a well water system;

FIG. 9 is an exploded view of the modular adaptor of FIG. 8;

FIG. 10 is side view of the modular adaptor of FIG. 8 with the adaptor base and adaptor coupler connected;

FIG. 11 is side view of the modular adaptor of FIG. 8 with the adaptor base and adaptor coupler disconnected;

FIG. 12 is a simplified side view of another exemplary well water system of this invention using the modular adaptor of FIG. 8;

FIG. 13 is side view of the modular adaptor of FIG. 8 with the adaptor base and adaptor coupler connected;

FIG. 14 is side view of the modular adaptor of FIG. 8 with the adaptor base and adaptor coupler being disconnected; and

FIG. 15 is side view of the modular adaptor of FIG. 8 with the adaptor base and adaptor coupler being disconnected.

### DESCRIPTION OF THE PREFERRED EMBODIMENT

In the following detailed description of the preferred embodiments, reference is made to the accompanying drawings that form a part hereof, and in which is shown by way of illustration specific preferred embodiments in which the invention may be practiced. These embodiments are described in sufficient detail to enable those skilled in the art to practice the invention, and it is understood that other embodiments may be utilized and that logical, structural, mechanical, electrical, and chemical changes may be made without departing from the spirit or scope of the invention. To avoid detail not necessary to enable those skilled in the art to practice the invention, the description may omit certain information known to those skilled in the art. The following detailed description is, therefore, not to be taken in a limiting sense, and the scope of the present invention is defined only by the appended claims.

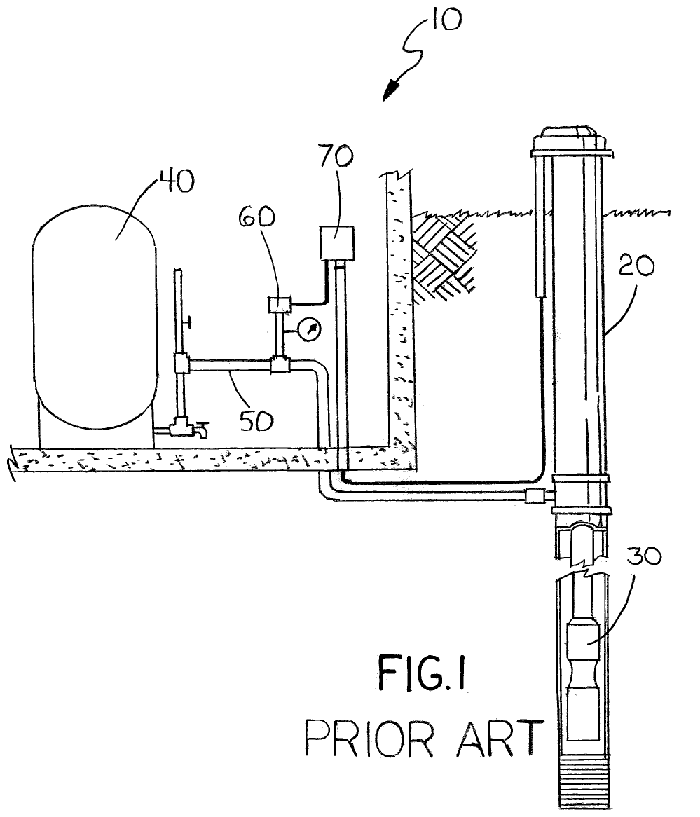

FIG. 1 illustrates a conventional well water system 10 that is presented to assist in the explanation of the prior art and conventional practices of basic well water systems, which may be contrasted to the present invention described further below. Well water systems 10 generally consist of a well casing 20, submersible pump 30, pressure tank 40, plumbing 50, pressure switch 60, and an electrical relay 70. Well casing 20 extends into the subterranean aquifer. Pump 30 is disposed within well casing 20 below the water line. Pressure tank 40 is remotely located and pump 30 feeds pressure tank 40 through plumbing 50. Plumbing 50 includes various pipes, joints, valves, spigots and faucets. Pressure switch 60 is operatively connected within plumbing 50 and detects the water pressure in the system. Electrical wires 72 connect pressure switch 60 to relay 70. Relay 70 electrically wires pump 30 to a power source (not shown) and actuates pump 30 in response to an electrical signal from pressure switch 60.

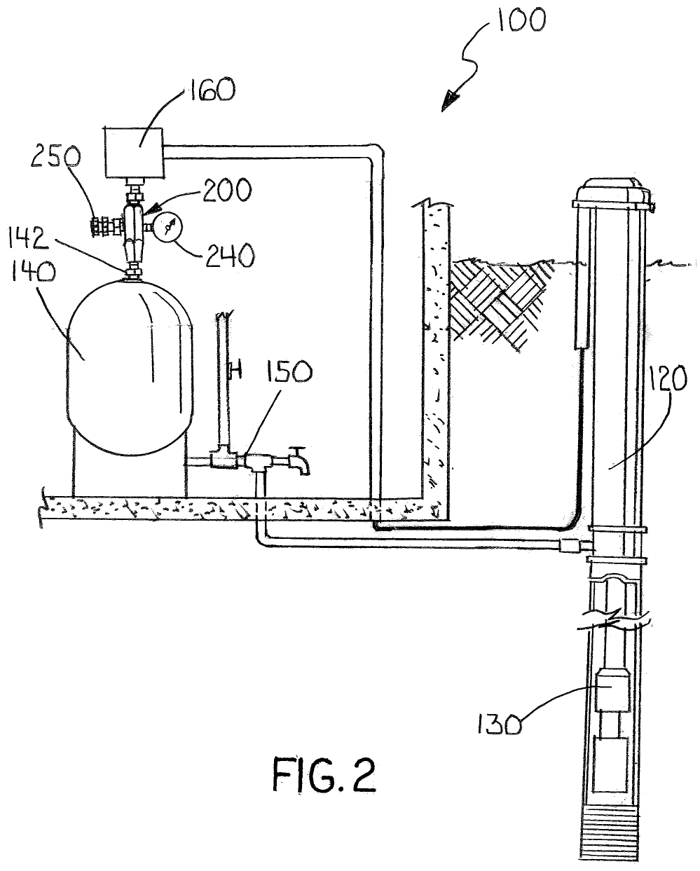

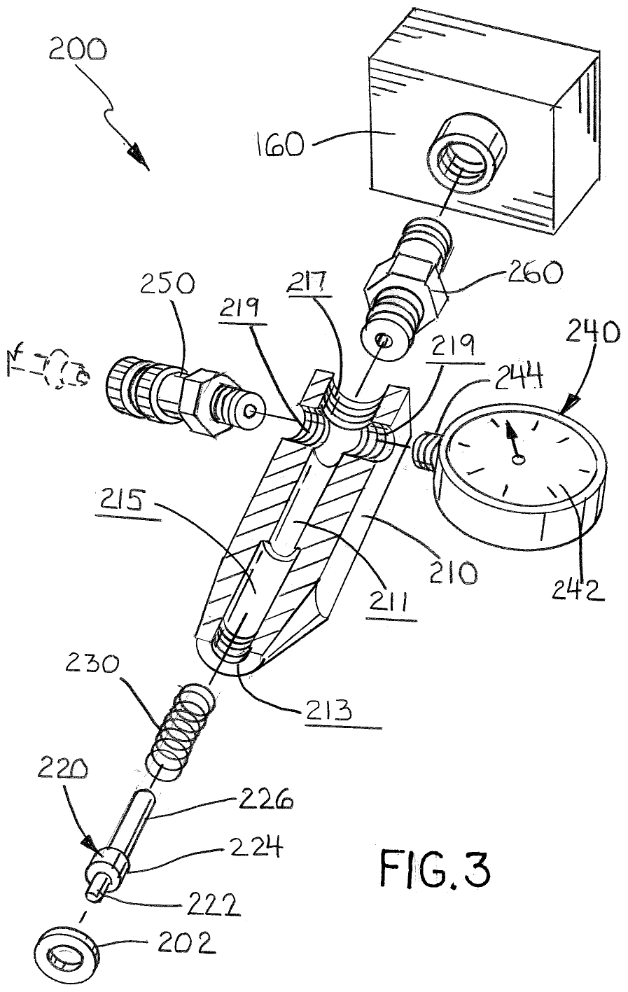

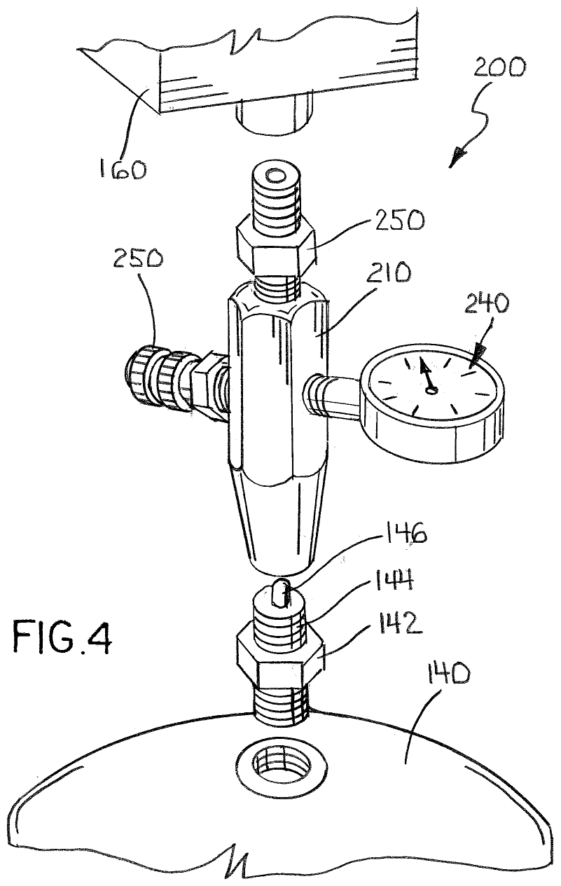

Referring now to the drawings, FIGS. 2-4 illustrate an exemplary embodiment of the well water system of this invention, which is designated generally as reference numeral 100. As with a conventional system, well water system 100 consists of a well casing 120, submersible pump 130, pressure tank 140, plumbing 150, pressure control 160, which may take the form of in certain applications and systems as conventional pressure transducers or pressure switches, and an electrical relay 170. Again, well casing 120 extends into the subterranean aquifer. Pump 130 is disposed within well casing 120 and feeds pressure tank 140 through standard plumbing 150. As shown, pressure control 160, is a pressure switch electrically wired to pump 130 and an external power source (not shown), which actuates the pump in response to an electrical signal from pressure control 160.

The pumps, pressure tanks, relays and plumbing used in well water system 100 are all standard commercially available components for conventional design and function, well known in the art. In every case, well water system 100 of this invention differs from conventional well water systems, such as the one described above, in that the pressure control 160 is adapted to monitor air pressure within pressure tank 140, rather than water pressure within plumbing 150. Pressure control 160 is connected to pressure tank 140 by a tank adaptor 200 in fluid communication with the pressurized air inside the tank. In other exemplary embodiments, pressure control 160 may take the form of a combination of pressure sensor and transducer, which are also commonly used in well water systems; however, such sensor and transducer combinations still monitor and actuate pump 120 based on air pressure within pressure tank 120, and not the water within the plumbing.

Tank adaptor 200 includes a hollow body 210, a pressure gauge 240, a pneumatic coupler 250 adapted for connection to an external air source and a pneumatic connector 260 adapted for interface with pressure control 160. Adaptor body 210 is a long hollow member cast or machined from a suitable material, such as brass or aluminum. Adaptor body 210 has an open axial passage 211 that extends the length of the body. A valve pin 220 and helical spring 230 are disposed within a pin channel 215 of passage 211. Valve pin 220 is machined or cast to have a head 222, an annular collar 224 and shaft 226. Spring 230 is seated on pin shaft 226 and compressed between collar 224 and an internal shoulder 212 from between passage 211 and pin channel 215. Valve pin 220 is dimensioned to shiftably seat within pin channel 215 and passage 211, so as to provide open fluid communication through adaptor body 210. In addition, adaptor body 210 has a thread tank port 113 and a threaded switch port 117 at opposite ends of open passage 211. Adaptor body 210 also has two threaded side ports 219 that open into passage 211. Pressure gauge 240 is of conventional design and function and includes a gauge body 242 and threaded male connector 244 turned into one of the side ports 219. A pneumatic coupler 250 is a conventional quick connect pneumatic coupler, such as the MNPT M Style coupler manufactured by Milton Industries, Inc. of Chicago, Ill. Coupler 150 allows the quick attachment of air lines from a conventional air compressor to initially inflate and pressurize tank 140 as necessary. It should be noted that unless the coupler 150 is connected to a mating component of the air line, the couple is “closed” sealing its threaded side port 219. Pneumatic connector 260 is also of conventional design and interfaces adaptor body 210 in open fluid communication to pressure control 160. Typically, the body of pressure control 160 turns onto the threaded end of connector 260, which is turned into threaded port 217 of adaptor body 210.

As shown, tank adaptor 200 is configured to affix directly to air valve 142 of pressure tank 140. Generally, air valve 142 is a “Schrader” or “American” type or similar pneumatic valve used to connect the tank to an air source, such as the air line from an air compressor, for initially pressurizing the tank. Air valve 142 has a threaded head 144 and a valve core 146. Tank adaptor 200 is affixed to pressure tank 140 by turning threaded tank port 213 of adaptor body 219 onto the threaded head of tank valve 142 with a gasket 202. When affixed, valve pin 220 under the force of spring 230 depresses valve core 146 of tank 142 to provide open fluid communication from the tank through passage 211 to pressure switch 160. In other embodiments of this invention, the interface between the tank adaptor and air valve may vary depending on the type and configuration of the pressure tank.

With tank adaptor 200 connecting pressure tank 140 to pressure switch 160, pump 130 is actuated based on air pressure changes within the tank rather than water pressure changes in plumbing 150. Pressure switch 160 is calibrated to activate pump 130 when the air pressure within pressure tank 140 drops below a predetermined pressure, which correlates to a certain water pressure within plumbing 150. When the air pressure within pressure tank 140 is restored to a predetermined maximum, pressure switch 160 deactivates pump 130 having filled the tank to the desired maximum water threshold.

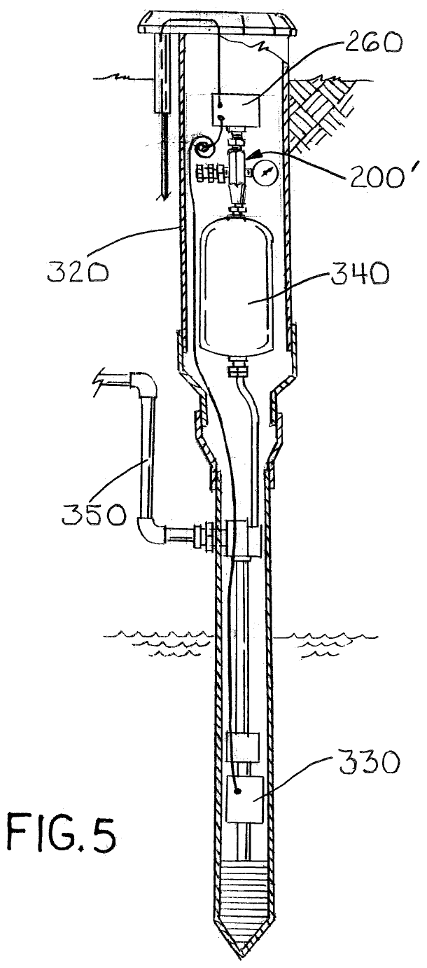

FIG. 5 illustrates a second exemplary embodiment of the well water system of this invention, which is designated generally as reference numeral 300. Well water system 300 is a typical “pitless” system and operates in the same manner as well water systems 10 and 100 above. In well water system 300, pressure tank 340 is disposed within the well casing 310. Again, pressure switch or pressure transducer 360 is connected directly to pressure tank 340 by a tank adaptor 200′ in fluid communication with the pressurized air inside the tank, and pump 330 is actuated based on air pressure changes within the tank rather than water pressure changes in the plumbing. Tank adaptor 200′ is mounted directly to the air valve (not shown) of pressure tank 340, which locates coupler 250′ where it is easily accessible from the well head. With easy access to coupler 250′, an air line can be readily connected to pressure tank 340 through adaptor 200′ to initially fill and periodically pressurize the tank as required.

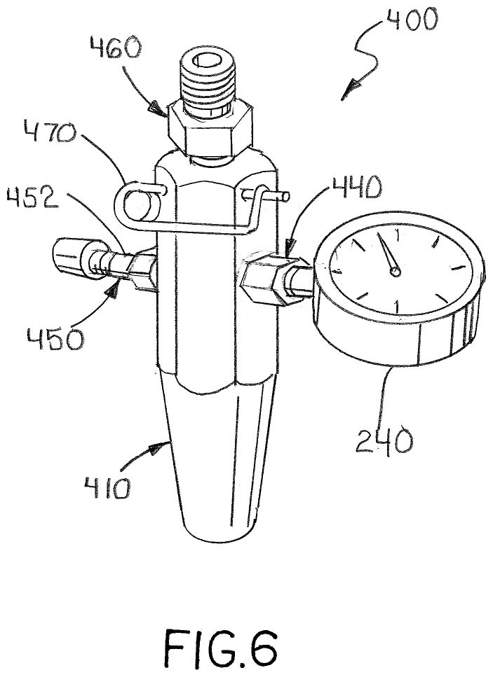

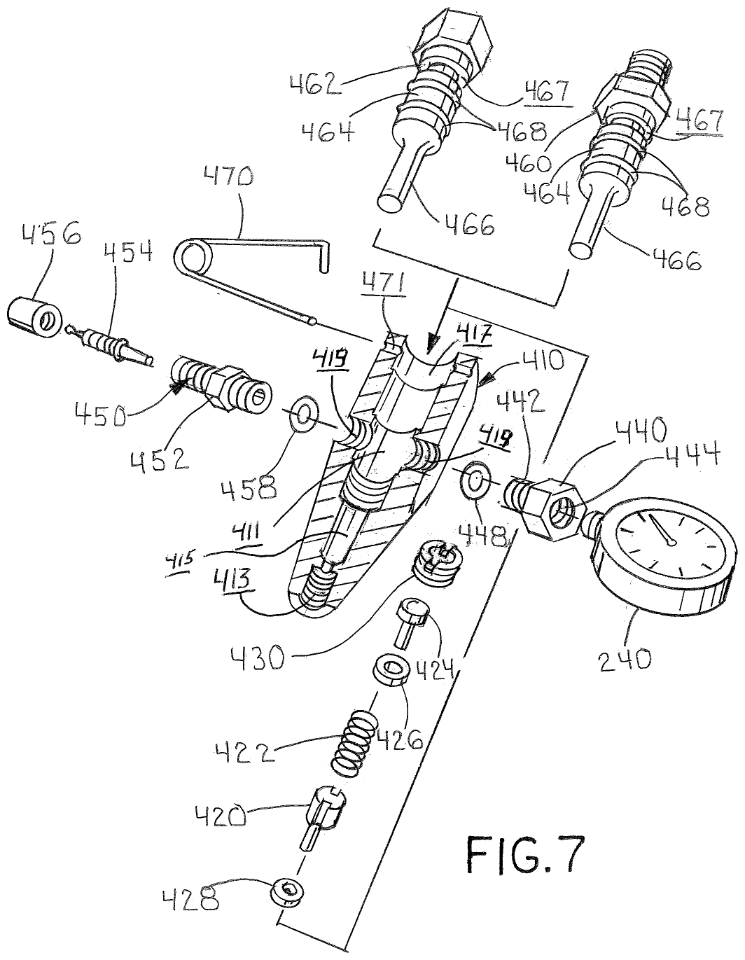

FIGS. 6 and 7 illustrate a second exemplary embodiment of the tank adaptor of this invention, which is designated generally as reference numeral 400. Tank adaptor 400 is similar to tank adaptor 200 in function and use within the well system, but provides increased leak prevention with the use of multiple O-rings. Tank adaptor body 400 also includes an integrated “Schrader valve” 450, an integrated gauge fitting 440, and a pair of interchangeable switch/transducer heads 460 and 462. Switch/transducer heads 460 and 462 can be selectively fitted to adaptor body 410 for use with either a conventional pressure switch or a conventional pressure transducer as pressure controls. Each of the Schrader valve stem 450, gauge port 440 and heads 460 and 462 have one or more O-rings that hermetically seal their connections to adaptor body 410.

Adaptor body 410 is a long hollow member cast or machined from a suitable material, such as brass or aluminum. Adaptor body 410 has an open axial passage 411 that extends the length of the body with a threaded tank end 413 and an open switch/transducer end 417 at opposite ends of open passage 411. Adaptor body 410 also has two threaded side ports 419 that open into passage 411. As before, adaptor body 410 houses internal valve components that provided selective fluid communication through passage 411. The internal valve components including a valve pin 420, helical spring 422, valve head 424 and valve gasket 426 are disposed within a valve channel 415 of passage 411. Spring 422 is seated between valve pin 420 and valve head 424. The valve components are held within valve channel 415 by an externally threaded annular barrel 430 that turns into an internally threaded section of passage 411.

Gauge fitting 440 allows a conventional pressure gauge 240 to be directly affixed to adaptor body 410. Gauge fitting 440 has an externally threaded male end 442 and an internally threaded female end 444 that is adapted to received the male end of a conventional pressure gauge (not shown). The male end 442 is turned into one of the side ports 419 and is sealed by O-ring 448.

Air valve 450 includes a valve stem 452 that houses an internal valve component 454. Valve stem 452 has an externally threaded male end that turns into side port 419 and is sealed by O-ring 458. Air valve 450 functions as a conventional “Schrader” valve and allows air to be added to a connected pressure tank through adapter body 410, replacing pneumatic coupler 250 of the previous embodiment.

Switch/transducer heads 460 and 462 are identical in construction and function with head 460 having a threaded male end adapted to affix to a conventional pressure switch (not shown) and head 462 having a threaded female end adapted to be affixed to a conventional pressure transducer (not shown). Heads 460 and 462 have a hollow body 464 with a neck 466 configured to seat within end 417. Heads 460 and 462 each have a pair of O-rings 468 seated in annular grooves formed around body 464, which allow the heads to be press fitted into adaptor body 410. Switch/transducer heads 460 and 462 are secured to adaptor body 410 by a safety pin 470 that extends through a cross bore 471 in adaptor body 410 and rests across an annular groove 467 in the switch/transducer heads. The press fit connection and locking safety pin, allow switch/transducer heads 460 and 462 to be quickly interchanged without tools.

One skilled in the art will note that placing the pressure switch in an air line, rather than a water line, eliminates potential water leaks and certain plumbing issues, that can lead to costly water damage to the system and surrounding structures. Eliminating the pressure switch from the plumbing also reduces the installation costs of the system. Using the pressure switch to monitor air pressure in the pressure tank also conveniently locates the switch atop the pressure tank where it is easily accessible, which is particularly useful in pitless well water systems. The use of a pressure switch in the air line, rather than the water line also does not significantly change configuration or function of any system component, plumbing or wiring, keeping system installation, operation and maintenance familiar, while reducing cost and increasing reliability.

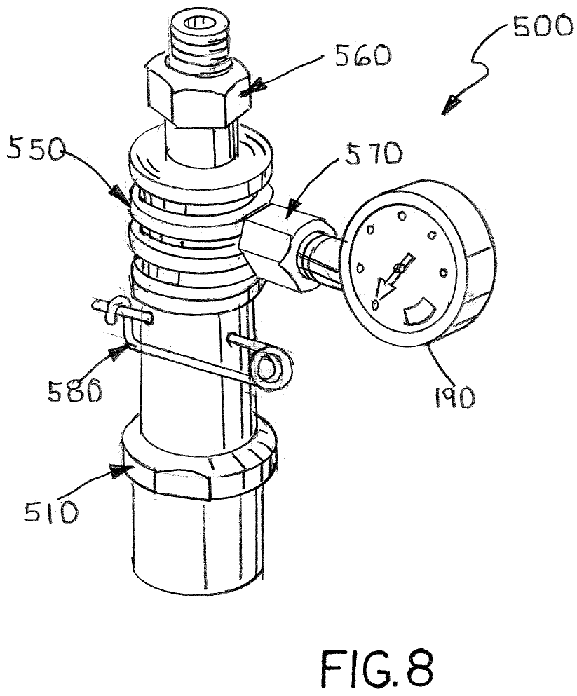

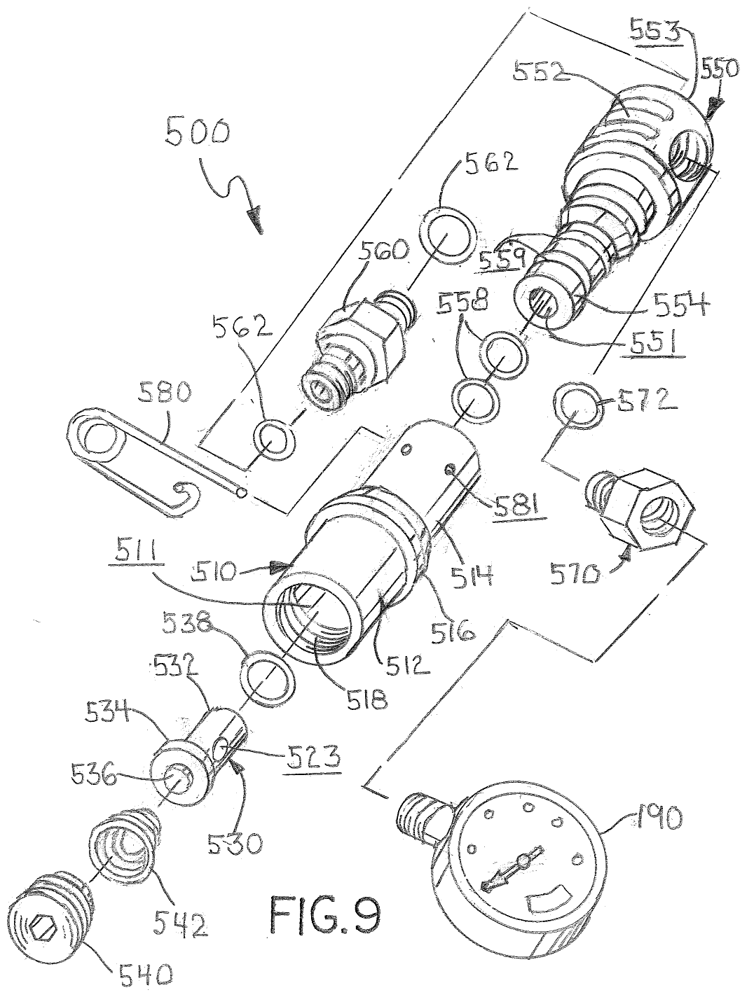

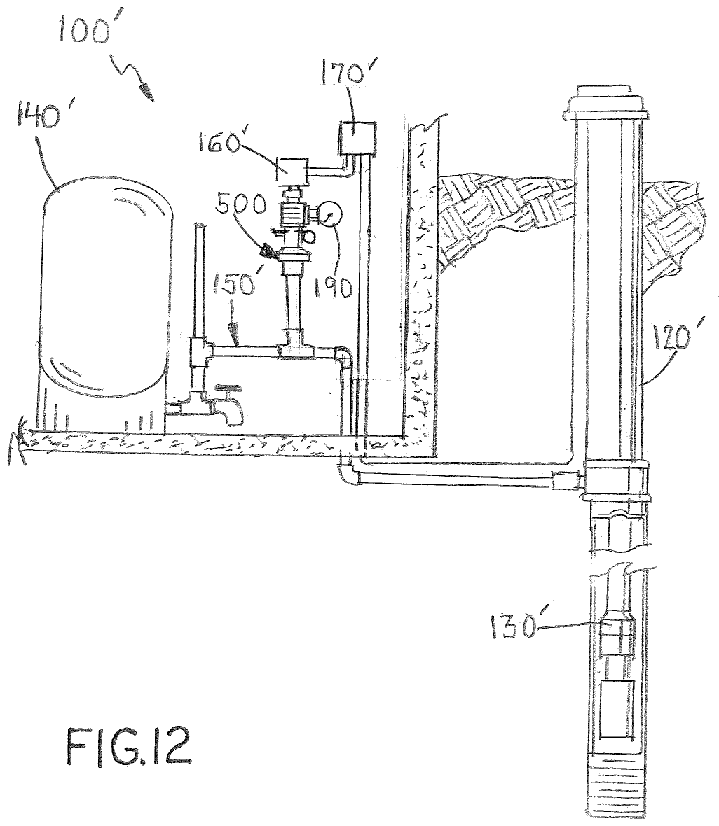

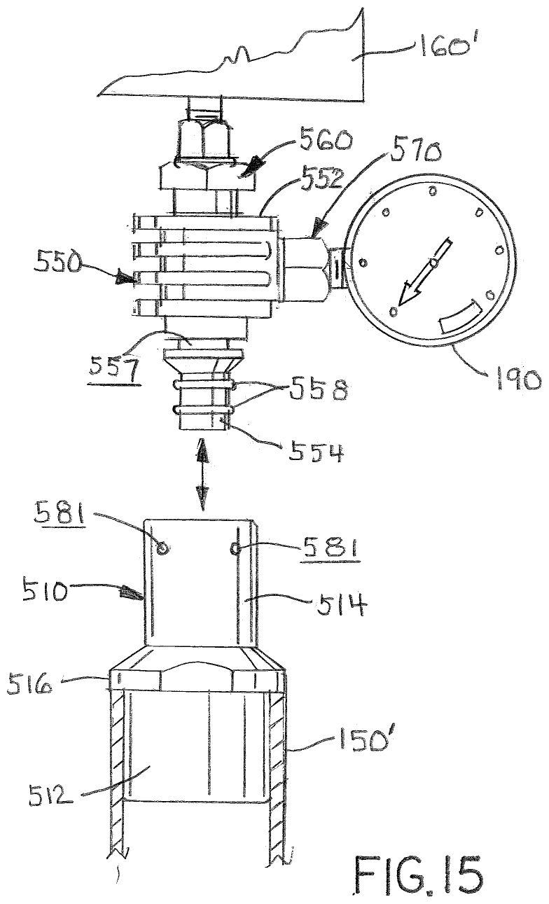

FIGS. 8-15 illustrate conventional well water system 100 that monitors water pressure within the plumbing, but incorporates a two piece modular adaptor 500 that allows the pressure controls to be readily detached from the well water system 100′. Modular adaptor 500 includes a hollow body 510 and a detachable coupler 550, which connects the pressure control and a pressure gauge to adaptor 500. The detachable coupler 550 allows the pressure controller to be completely disconnected from the well water system without reworking the existing plumbing and reduces the potential of major water leaks. In addition, modular adaptor 500 is designed to be installed to conventional PVC water pipes and fitting used in the well water system. Adaptor body 510 and coupler 550 are molded or formed from a PVC or other suitable polymer plastic, and use two metal fittings and a number of rubber O-rings to detachably connect pressure controllers and pressure gauges in a sealed fluid engagement within well water system 100. The configuration of modular adaptor 500 allows it to be fitted to conventional PVC piping and fitting, which reduces installation and repair costs by eliminating the need to cut, join and solder metal pipes and fittings.

Adaptor body 510 has a cylindrical shape and an axial passages 511 therethrough. Adaptor body 510 has a couple end 512 and a fitting end 514 separated by an external annular rib 516 that extends outward from its exterior sidewall. Fitting end 514 of body 510 has an internal threaded bottom opening 518. An end cap 240 is a flat disc with a threaded sidewall, which turns into threaded opening 518 of body 510. Adaptor body 510 also has an internal annular shoulder 520 that protrudes into passage 511, which forms a valve channel 223 and angled valve seat 524. Passage 511 has a coupler section 525 defined by a cylindrical passage wall 226 at the connector end 512 and a fitting section 527 defined second cylindrical passage wall 228 at the fitting end 514, which are in communication through valve channel 223.

A valve component 530 is reciprocally disposed within body 510. Valve component 530 includes a cylindrical shank 532 and an annular end flange 534. A spring stem 536 extends axially from shank past flange 534. Valve component 530 has a bore 533 extending laterally through shank 532. A rubber O-ring 538 is seated around shank 532 and nests against flange 534. Valve component 530 is held against valve seat 524 by a helical spring 542. Spring 542 is disposed between valve component 530 and end cap 540 with one end seated on string stem 536 and the other end pressed against end cap 540. Shank 532 reciprocally extends into valve channel 523. In a closed position, spring 542 holds valve component 530 against valve seat 524 preventing fluid flow through passage 511. In an open position, water pressure counters the spring forces from spring 538 unseating valve component 530 so that fluid flows through lateral bore 533, valve 523 and through passage 511.

Adaptor coupler 550 is detachably connected to body 510 and secured by a pin clip 570. Adaptor coupler 550 connects a pressure control 160 and pressure gauge 190 to adaptor 500. Again, pressure control 160 can be a conventional pressure switch or transducer. Pressure gauge 190 is a conventional water pressure gauge. Conventional metal connectors 560 and 570 connect coupler 550 to pressure gauge 190 and pressure control 160′. O-rings 562 and 572 seal the engagement of pressure gauge 190 and pressure control 160′ to connectors 560 and 570.

Adaptor coupler 550 includes a coupler head 552 and a cylindrical coupler neck 554 that extends integrally from the head. An axial passage 551 extends through coupler head 552 and coupler neck 554. Passage 551 has an internally threaded end 553. Control connector 560 is turned into threaded end 553 and sealed by an O-ring 562. Head 552 has a threaded lateral bore 555. Gauge connector 540 is turned into bore 555 and sealed by an O-ring 542. A pair of O-rings 558 are seated in annular grooves 559 on coupler neck 554. Coupler neck 554 also has a annular groove 557. Coupler neck 554 presses into and seats within coupler section 525 of passage 511 and is sealed by the engagement of O-rings 558 against passage wall 526. When coupler 550 is fully seated within body 510, neck 554 displaces valve 530 slightly from valve channel 523 into an open position allowing fluid flow through adaptor 500. Coupler 550 is secured to body 510 in the open position by pin clip 580, which extends through aligned tangential bores in couple end 512 and seats into annular groove 557 of coupler neck 554. When pin clip 570 is removed, adaptor coupler 550 can be manually disconnected from body 510. When coupler 550 is detached from body 510, valve 530 is biased against valve seat 524 in a closed position, preventing fluid flow through adaptor 500.

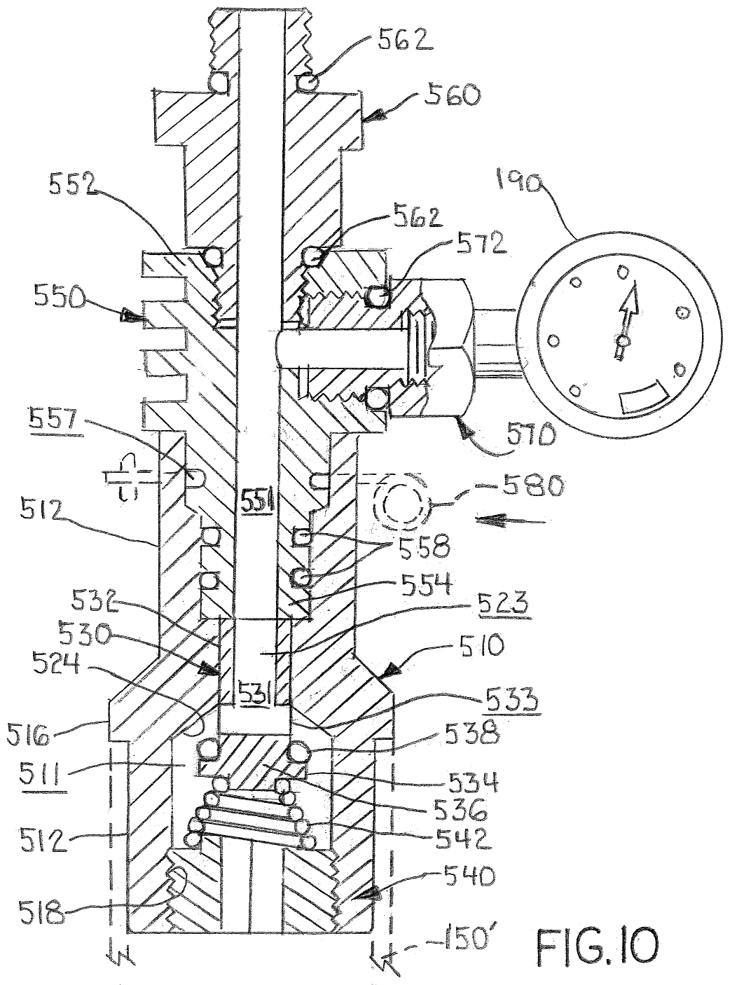

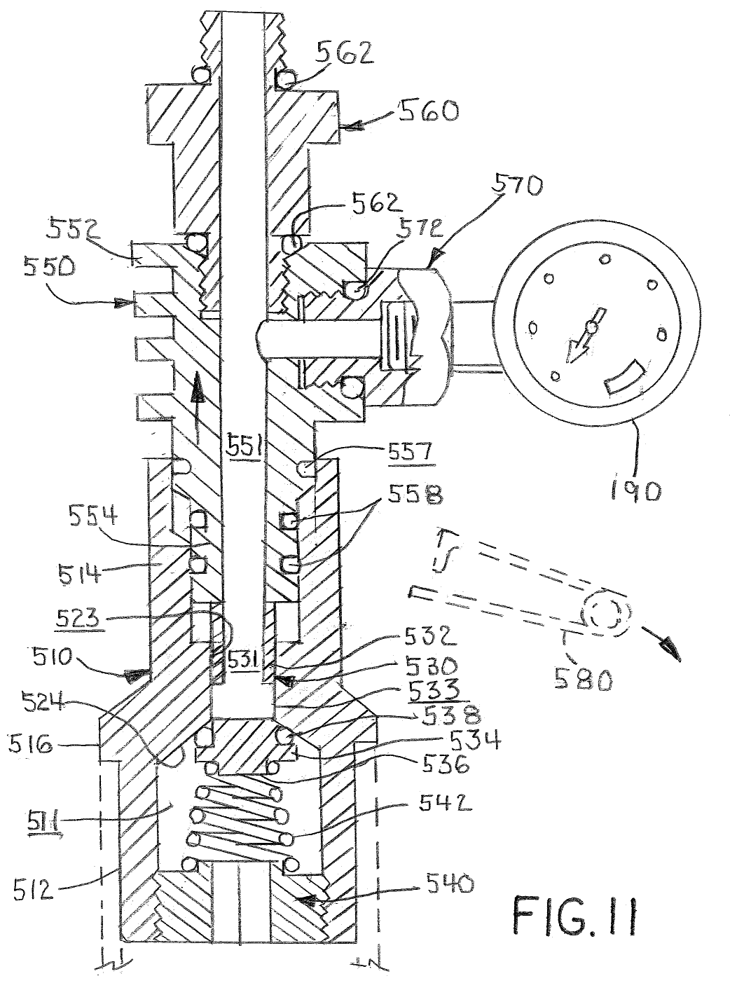

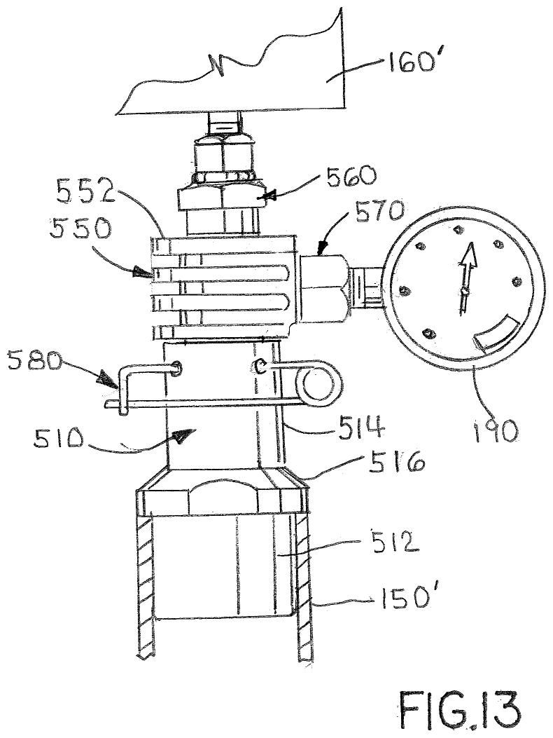

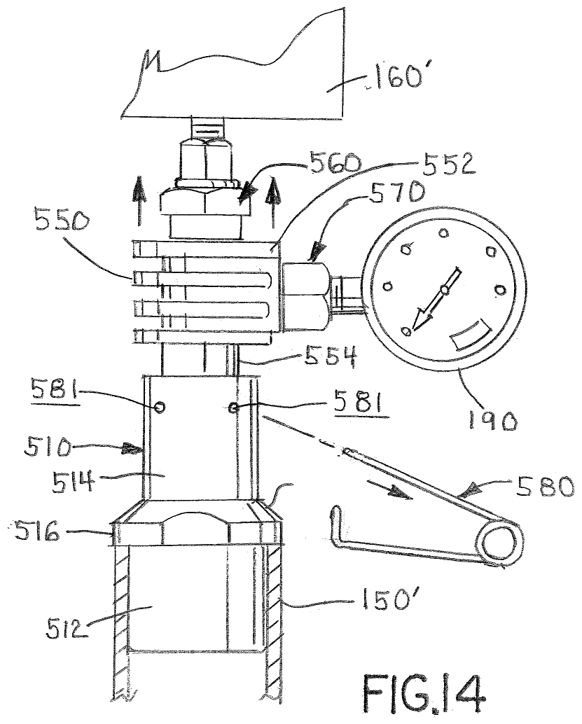

FIG. 14 shows modular adaptor 500 installed in a conventional well water system 100. Again, well water system 100 consists of a well casing 120, submersible pump 130, pressure tank 190, plumbing 150, pressure control 160, which may take the form of in certain applications and systems conventional pressure transducers or pressure switches, and an electrical relay 170. With adaptor coupler 550 attached to body 510, valve 530 is in a normally open position allowing water flow through adaptor 500 in fluid communication with pressure control 160 and pressure gauge 190 (FIGS. 10 and 13). Disconnecting coupler 550 from body 510, automatically closes valve 530 and prevents any fluid flow through body 510 (FIGS. 11, 14 and 15).

It should be apparent from the foregoing that an invention having significant advantages has been provided. While the invention is shown in only a few of its forms, it is not just limited but is susceptible to various changes and modifications without departing from the spirit thereof. The embodiment of the present invention herein described and illustrated is not intended to be exhaustive or to limit the invention to the precise form disclosed. It is presented to explain the invention so that others skilled in the art might utilize its teachings. The embodiment of the present invention may be modified within the scope of the following claims.

We claim:

1. In a water pressure system including a pump for pumping water from a water bearing aquifer, a pressure tank connected to the pump by a water conduit, the pressure tank including an inlet end, an outlet end, and an outer housing that is fillable with water from the submersible pump for storing a reserve of water, system plumbing connecting the pump and pressure tank, and a pressure control for monitoring water pressure in the system plumbing and controlling operation of the pump, a modular adaptor connecting a pressure control to the system plumbing comprising:
an adaptor body mountable to the system plumbing;
an adaptor coupler connected to the pressure control and detachably connected to the adaptor body; and
a valve disposed within the adaptor body and operatively abutting the adaptor coupler to allow fluid flow through the modular adaptor from the system plumbing when the adaptor coupler is connected to the adaptor body and to prevent fluid flow through the modular adaptor when the adaptor coupler is disconnected from the adaptor body.

2. The modular adaptor of claim 1 wherein the adaptor body has a first body end and a second body end, the first body end adapted to connect to the system plumbing, the second body end configured to receive the adaptor coupler.

3. The modular adaptor of claim 2 wherein the adaptor body has an axial through passage therein between the first body end and the second body end.

4. The modular adaptor of claim 3 wherein the body passage defines a valve seat, the valve shiftably disposed within the body passage to engage the valve seat to prevent fluid flow through the modular adaptor.

5. The modular adaptor of claim 2 wherein the adaptor coupler includes a coupler head and a coupler neck, the coupler neck configured to seat in sealed engagement within the second body end of the adaptor body.

6. The modular adaptor of claim 5 wherein the coupler neck and the coupler head has an axial through coupler passage therein,

7. The modular adaptor of claim 6 wherein the coupler head includes a first connector for connecting the pressure control to the adaptor coupler in open fluid communication with the coupler passage

8. The modular adaptor of claim 7 wherein the coupler head also includes a second connector for connecting a pressure gauge to the adaptor coupler.

9. The modular adaptor of claim 1 and a lock for securing the adaptor coupler to the adaptor body.

10. The modular adaptor of claim 9 wherein the adaptor coupler has an annular groove therein disposed within the adaptor body when the adaptor coupler is connected to the adaptor body, the adaptor body having a tangential bore therethrough, the tangential bore aligned with the annular groove of the adaptor coupler when the adaptor coupler is connected to the adaptor body, the lock includes a pin extending through the tangential bore of the adaptor body seating in the annular groove of the adaptor coupler to secure the adaptor coupler to the adaptor body.
